(19) United States
(12) Patent Application Publication
(10) Pub. No.: US 2018/0109739 A1
(43) Pub. Date: Apr. 19, 2018

(54) APPARATUS, SYSTEM AND METHOD OF MODIFYING AN IMAGE SENSOR TO ACHIEVE HYPERSPECTRAL IMAGING IN LOW LIGHT

(71) Applicants: James Foley, Las Vegas, NV (US); Randall Kolchins, Las Vegas, NV (US); Shlomo Ben-Efraim, Las Vegas, NV (US)

(72) Inventors: James Foley, Las Vegas, NV (US); Randall Kolchins, Las Vegas, NV (US); Shlomo Ben-Efraim, Las Vegas, NV (US)

(21) Appl. No.: 15/298,146

(22) Filed: Oct. 19, 2016

(51) Int. Cl. H04N 5/33; H04N 17/00; H04N 9/73

(52) U.S. Cl. CPC H04N 5/332; H04N 9/735; H04N 17/002

(57) ABSTRACT

A method of modifying a stock image sensor to achieve hyperspectral imaging capability in low light. This method may including steps of disassembling a stock CMOS image sensor; removing one or more IR filters disposed above a photodector array; adjusting a white balance profile to change the output from the image sensor; recalibrating the position of the photodetector array; and incorporating the image sensor into a night visions device (NVD) with a more appropriate or rugged housing.

### BACKGROUND OF THE INVENTION

### Field of the Invention

This invention relates to night vision apparti, and more particularly relates to an apparatus, system and method for modifying a CMOS image sensor to achieve higher sensitivity and increased spectrum sensitivity with diminished input of signal light (while separating the colors spatially)

### Description of the Related Art

Night vision goggles devices (NVDs) and display apparti are well-known in the art. NVD technology has passed through four to five generally recognized generations, each comprising monochrome output displays, taking white light and amplifying input to produce a monochrome in green due to the phosphors used. Some earlier generation amplification techniques included twin synchronized spinning color filter wheels in front and back of an image intensifier tube assembly.

Using light reflected from an object or scene by intensifying the image reflection and generating a monochrome image, traditional NVDs could improve human perception of a darkened vista. Traditional NVDs used an image intensifier tube as an optical amplifier. Emitted photons which strike the entrance to the intensifier are converted to electrons by a photo-cathode. Photons entering the image intensifier tube are magnified up to 50,000 times to produce an image for the NVD wearer in low light conditions (exemplified by overcast moonless nights).

An electric field applied between the photo-cathode and Micro Channel Plate (MCP) accelerated the electrons, amplifying the number of incoming accelerated electrons that ultimately bombard monochrome phosphors on a phosphorous screen. The phosphorous screen converts the amplified electrons back to photons, thereby displaying an amplified analog image represented by green shades of intensity.

In some embodiments, an image sensor, e.g. CCD (Charged Coupled Device) or CMOS (Complimentary Metal Oxide Semiconductor) imager, detects the amplified image and translates it into a monochrome video signal.

Some intensifiers comprised a primary (RGB) color filter matrix screen printed on a glass wafer which is laminated to the input faceplate of the tube between a faceplate and the photocathode. The matrix filters light into primary components, which are amplified by the tube.

Image intensifiers of earlier generation NVD continue to suffer from a variety of weaknesses and inefficiencies however. Image intensifiers have a peak response curve in roughly the 600-900 nm range, which only partially covers the visible light spectrum and which does not cover a wavelength of 1064 nm (commonly used by military targeting lasers). The image intensifiers filter out the near infrared (IR) portion of the spectrum which the image intensifier is sensitive to. Additionally, images on the phosphor screen are not easily digitized or relayed beyond the intensifying tube itself. The image intensifiers themselves degrade and dim over time and can be ruined in moments by exposure to bright light exposure such as from the sun or a laser.

Color night vision is far more desirable than monochrome, and has traditionally been achieved through use of an intensifier tube providing a monochrome output in connection with input and output color members for passing respective different light frequencies. The input color member filters the incoming light to the tube of each light spectrum band in time succession and the monochrome output of the tube passes through an output color filter to produce a corresponding color component.

Progressions in the art incorporated spatial color filters in both the input and output of the image intensifier, including colored fiber optic cables or colored micro-lenses. Alternatively, input color filters such as a filter wheel, a sequential filter or micro-lenses, were used. The output of the image intensifier was then coupled directly to a CCD or CMOS, or other imaging electronics, often producing three separate color images that are superimposed forming a synthetic or false color image for users.

A color image is more desirable for military surveillance applications, for medical applications, for commercial applications, and for consumer applications. Night flying of fixed wing and rotary wing aircraft has become an important and viable tactic in modern warfare, as have aircraft in medicine (with respect medical rotary wing aircraft), particularly for viewing terrain in front of the aircraft.

The military in particular has a need for a more optimal low light imaging device which comprises a native digital interface for interconnecting warfighters in future connected battlespaces. In particular, the military would benefit from a CMOS based night vision system that can visualize color imagery in overcast moonless conditions with noise levels equal or better than tube based intensifier systems. Providing this technology is an object of the present invention.

The varying methods of synthetically producing a color image are all inefficient. Various embodiments of the prior art reduce incoming signals by as much as 80% through use of time color filters, white phosphors, and other inefficiencent components. This problem is pronounced in night flying of aircraft when stray light from avionic saturates the intensifier. The successful blockage of IR light has not been optimally achieved through other methods while maintenanomg color integrity from wide viewing angles and is not fully achieved by using an IR absorbing filter which negatively results in filtering some of the visible red light portion of the spectrum as well. Active pixel sensors (APS) having CCD or CMOS image sensors have not traditionally imaged well enough in low light conditions to be practical for desired applications.

The prior art teaches many methods of producing a false color image using intensifiers rather than a method of optimizing an image sensor to increase sensitivities to specific portions of the spectrum. It is therefore desirable, and an object of the present invention, to provide a method of modifying an image sensor of a commercially available digital camera to achieve higher sensitivity in low light conditions and increase spectrum sensitivity (while separating the colors spatially) and of repurposing this image sensor to perform optimally for desired low light applications.

### SUMMARY OF THE INVENTION

From the foregoing discussion, it should be apparent that a need exists for an apparatus, system and method of modifying an image sensor to achieve higher light and spectrum sensitivity for night vision applications. Beneficially, such an apparatus, system and method would overcome many of the difficulties with prior art by providing a means of expanding the capabilities of a stock imaging system by modifying an existing image sensor rather than manufacturing the image sensor anew in order to address the low light imaging needs of a plurality of industries, users, and applications; and in particular the U.S. military.

The present invention has been developed in response to the present state of the art, and in particular, in response to the safety problems and needs in the art that have not yet been fully solved by currently available aparati, systems and methods. Accordingly, the present invention has been developed to provide a method of modifying a stock image sensor to achieve hyperspectral imaging capability in low light, the steps of the method comprising: disassembling a stock CMOS image sensor; removing one or more IR filters disposed above a photodector array; adjusting a white balance profile to change the output from the image sensor; recalibrating the position of the photodetector array; incorporating the image sensor into a NVD with a ruggedized housing.

The method may further comprise integrating a clear window above the photodetector array in place of the removed filters. The method may also comprise removing one or more UV filters disposed above a photodector array (i.e. sensor array).

The method may additionally further comprise integrating an optic faster than F/1.1.

The step of adjusting the white balance profile may include: using a grey card to test the modified image sensor in a plurality of different lighting conditions to determine an optimal balance for the modified sensor, and one or more of the following: increasing the temperature settings; shifting white balance coloring; and decreasing the temperature settings.

The method may further comprise disposing the image sensor behind a clear glass protective window in a rugged outer housing. The method may further comprise integrating the image sensor into a WUXGA OLED binocular device for low light viewing.

The method may further comprise blending imaging output from the imaging sensor with thermal imaging data from a separate sensor to create a fused color digital image.

A second method of modifying a stock image sensor to achieve hyperspectral imaging capability in low light is also provided, the steps of the method comprising: disassembling a stock CMOS image sensor; removing one or more IR filters disposed above a photodector array; applying a custom white balance profile to output from the image sensor; recalibrating the position of the photodetector array; incorporating the image sensor into a NVD with a rugged housing; integrating a clear window above the photodetector array in place of the removed filters; integrating an optic faster than F/1.1.

The method may further comprise disposing the image sensor behind a clear glass protective window.

The method may also comprise integrating the image sensor into a WUXGA OLED binocular device for low light viewing.

In various embodiments, the method further comprises blending imaging output from the imaging sensor with thermal imaging data from a separate sensor to create a fused color digital image.

A method of modifying a stock digital camera to achieve hyperspectral imaging capability in low light is also provided, the steps of the method comprising: disassembling a stock CMOS image sensor in the camera; removing one or more IR filters disposed above a photodector array; adjusting a white balance profile to change the output from the image sensor; recalibrating the position of the photodetector array relative to one or more filters; incorporating the image sensor into a NVD with a rugged housing.

In some embodiments, the method further comprises integrating a clear window above the photodetector array in place of the removed filters. The method may also comprise removing one or more UV filters disposed above a photodector array.

The method may also further comprise integrating an optic faster than F/1.1.

The step of adjusting the white balance profile may include: using a grey card to test the modified image sensor in a plurality of different lighting conditions to determine an optimal balance for the modified sensor, and one or more of: increasing the temperature settings; shifting white balance coloring; and decreasing the temperature settings.

The method also further comprises disposing the image sensor behind a clear glass protective window in a rugged housing. The method may also further comprise blending imaging output from the imaging sensor with thermal imaging data from a separate sensor to create a fused color digital image.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a rearward side elevational perspective view of a night vision goggle in accordance with the prior art;

FIG. 2 illustrates a rearward side elevational perspective view of an image sensor in accordance with the prior art;

FIG. 3 illustrates a forward side elevational perspective view of an image sensor in accordance with the present invention;

FIG. 4 illustrates a forward side perspective view of a night vision goggle in accordance with the present invention; and

FIG. 5 illustrates a flow chart of a method of modifying an image sensor to achieve higher sensitivity for low light imaging in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to convey a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

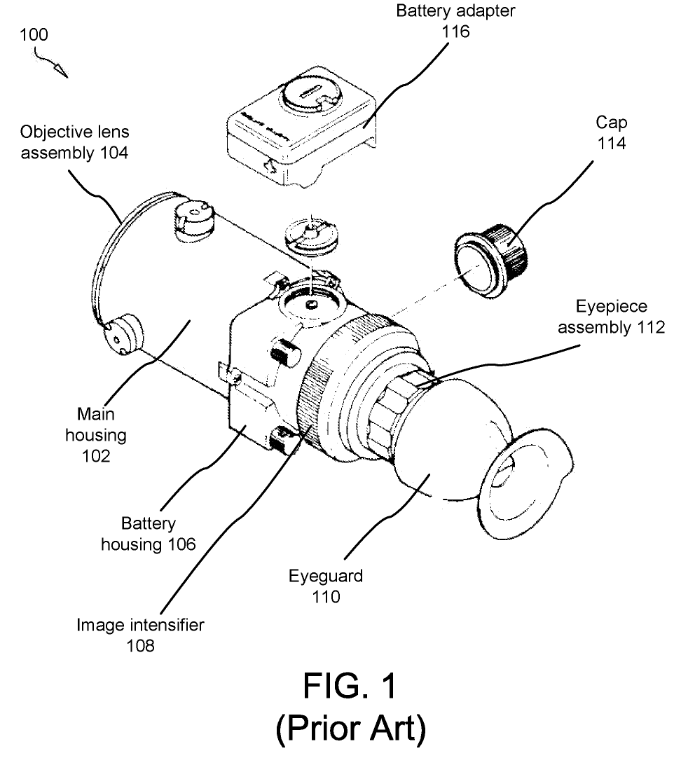

FIG. 1 illustrates a rearward side elevational perspective view of a night vision weapon sight 100 in accordance with the prior art.

The weapon sight 100 comprises a objective lens assembly 104, a main housing 102, a battery housing 106, an image intensifier 108, an eyeguard 110, a eyepiece assembly 112, a cap 114, and a battery adapter 116.

Like all earlier generation NVDs, the weapon sight 100 comprises in image intensifier 108 which is irradiated with white light which the NVG amplifies to produce a monochromatic image. Using light reflected from an object or scene by intensifying the image reflection and generating a monochrome image, the photons entering the intensifier are magnified up to 50,000 times.

The monochromatic image is viewed through the eyeguard assembly 110. The battery may de detachable and the image intensifier 108 is disposed between the objective lens assembly 104 and the eyepiece assembly 112.

For the reasons stated above, analog NVDs making use of image intensifiers suffer from a number of inefficiencies, including the fact they are sensitive to light primarily in the 600-900 nm wavelength range.

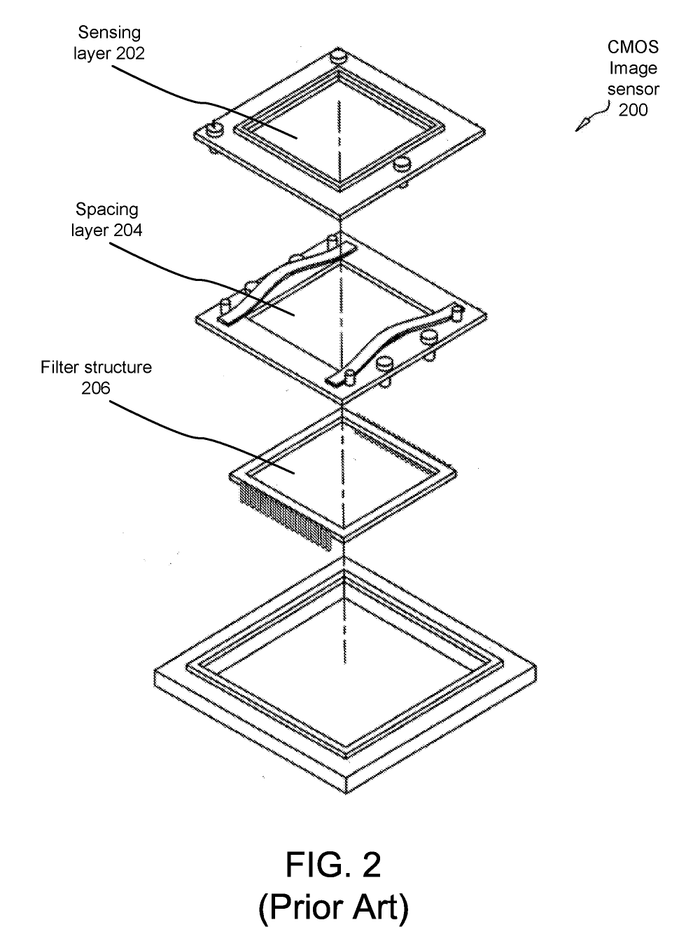

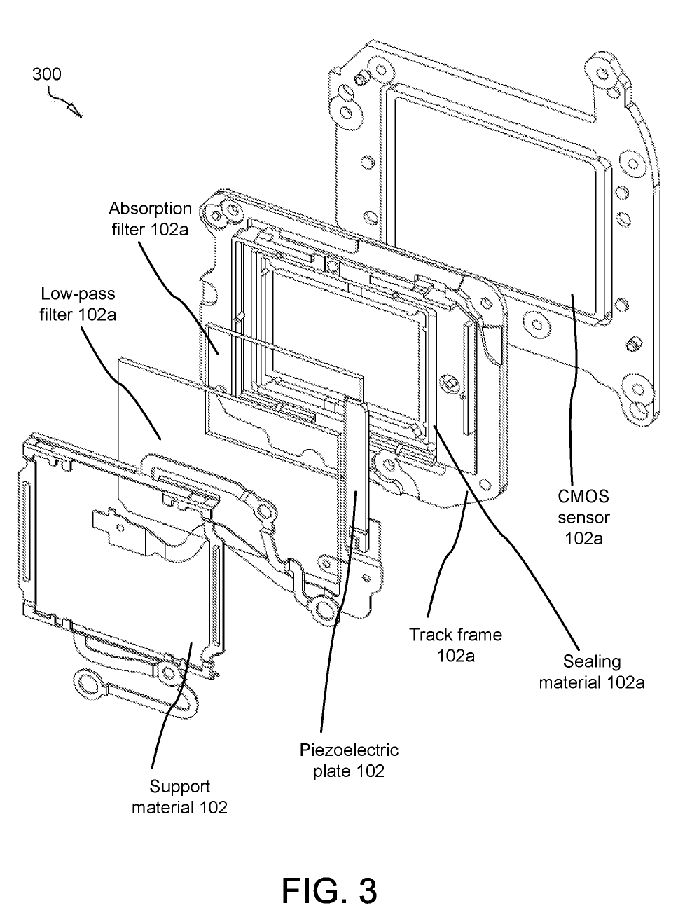

FIGS. 2-3 illustrates elevational perspective views of an image sensor 200, 300 in accordance with the prior art. The image sensor 200, 300 comprises a sensing layer 202, a spacing layer 204, and filter structure 206.

Modern digital cameras typically make use of an image sensor, which detects variable attenuation in light waves using an active pixel sensor (APS) in a CMOS incorporating an integrated circuit and converts the light into a computer-readable signal.

The image sensor 200 comprises a CMOS imaging chip with a photodector array with an amplifier for each pixel in the photodector array. The image sensors which are commercially available each comprise a number of lenses or filters (“cut filters”) in front of the photodector array which filter ultraviolet and infrared radiation beyond the visible spectrum, filter color, night glow, direct light, and/or widen area capture. The image sensor may comprise on-chip color filters. These filter include, in some embodiments, a layer filter sensor, a low-pass filter, an absorption filter, and the like.

In low light conditions, including during the night, the earth is illuminated with light in the 700 nm and above range, which is not visible to the human eye and which causes an effect known as night glow in ordinary photography applications. Commercially available image sensors filter out night glow using a cut filer which reduces, or eliminates, the practicality of the image sensor in military and other low light applications.

Examples of commercially available image sensors include: an AMS H18/H35 HV-CMOS, a BESiA/9959 Broadband Enhanced Spectrum Integrated Array, AMIS-722402 and others.

In accordance with the present invention, the image sensor 200, 300 is disassembled and UV and IR cut filters are removed from the image sensor. With respect to the BESiA/9959, this modification increases the wavelength response of the image sensor to approximately 390-1200 nm, which consequently results in the visual detection of a 1064 nm military targeting laser, but also results in a reddish imaging when the image sensor images in its stock umodified configuration.

In increasing the range, color rendition of the image sensor is drastically reduced and focus clarity is also reduced, complicating the usefulness of the image sensor in low light conditions and rendering any NVD incorporating the modified image sensor useless for color night vision applications. To cure this obstacle to color night vision tenability, in accordance with the present invention, a custom white balance profile is created and applied in computer readable memory to the digital image produced by the image sensor, restoring about 90% of the true color rendition of the original image sensor after application of the white balance profile parameters.

The modified white balance profile/specification includes adjustments to the color temperature setting, including increasing or decreasing them, as well as adjustments to the white balance coloring. In various embodiments, these changes to the white balance profile are made to a digital camera rather than the image sensor itself.

Focus clarity is restored to the BESiA/9959 Broadband Enhanced Spectrum Integrated Array image sensor after removal of the IR and UV filters by recalibrating the image sensor position and introducing a clear window into the sensor to create a proper imaging plane, causing the image sensor to behave as if the removed filters were still in place.

Other improvements to the image sensor include improving heat dissipation and weatherization by disassembling the image sensor 200, 300 to increase hink sinking capability then repackaging the sensor with thermal absorbing and/or conductive material behind the sensor (or behind the photodetector array), before disposing the modified sensor behind a clear glass protective window.

Subsequently, additional low light imaging benefit is derived from from integrating an f/0.95 lens with the sensor. Specific settings are applied to the image creating an “optimal image” including adjusting the shutter speed, ISO settings, and the like.

Optionally, output from the modified image sensor is combined, or blended, with output from a thermal imaging sensor and/or an image intensifier tube using sensor fusion to create a true digital nighttime digital image incorporating thermal and visual technologies from native digital output of the modified sensor and a thermal sensor.

The modified image sensor may be incorporated into COTI (clip on thermal imaging devices) used by the U.S. military (e.g. AN/PAS-29) to project a thermal image onto a monochromatic image produced by an image intensifier tube. The modified image sensor may also be incorporated into a dual WUXGA OLED Binocular night vision system, or into other systems known to those of skill in the art.

The modified NVD does not include 3CCD, EMCCD, CCD, or non-CMOS sensors.

All of these modifications make the modified sensor viable as a color night vision device.

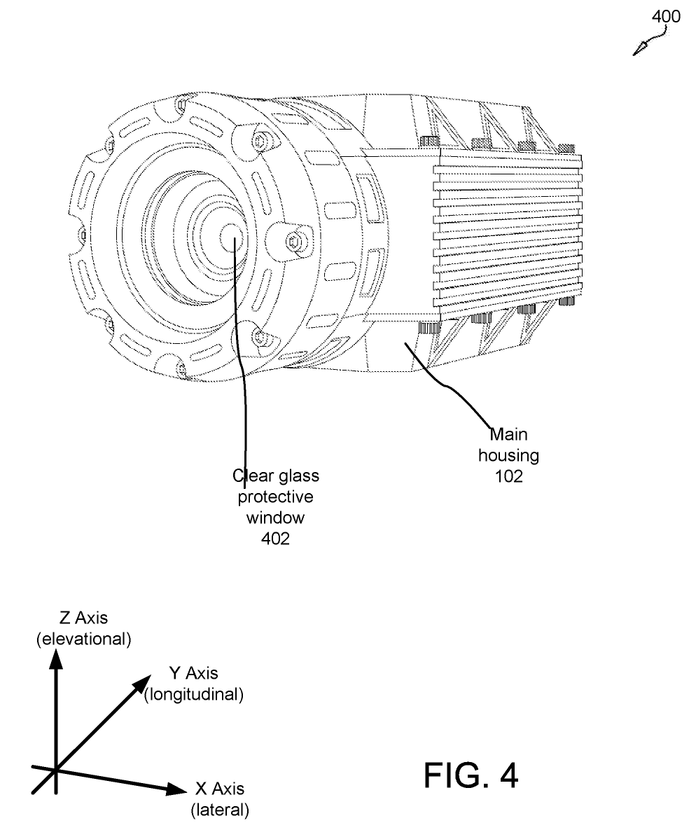

FIG. 4 illustrates a forward side perspective view of a night vision goggle 400 in accordance with the present invention, exemplifying a modified NGD which may be produced incorporating the modified image sensor, including a WUXGA OLED Binocular night vision system or a COTI.

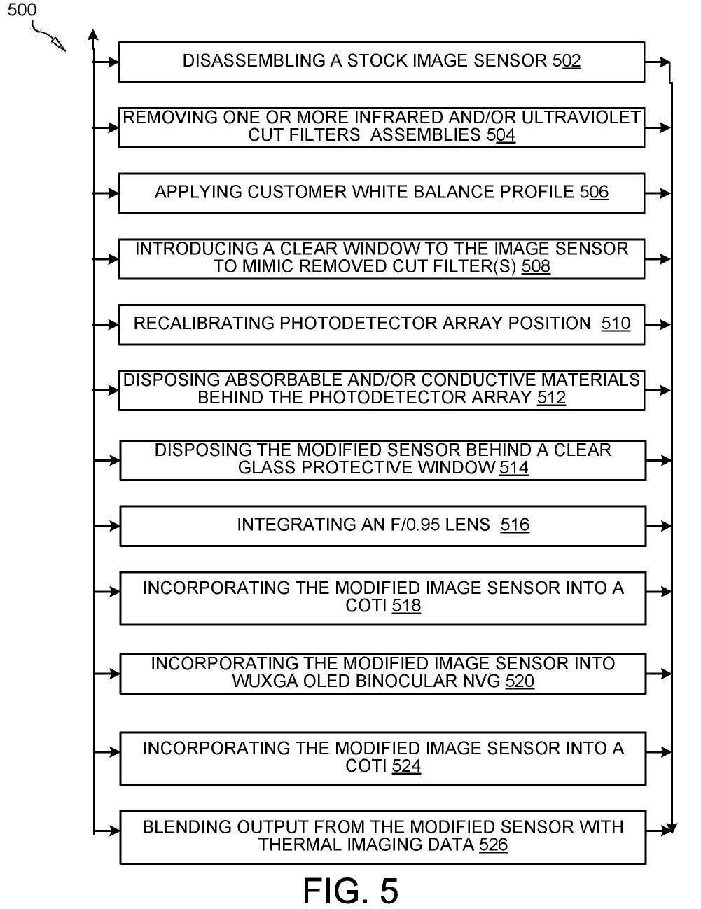

FIG. 5 illustrates a flow chart of a method 500 of modifying an image sensor to achieve higher sensitivity for low light imaging in accordance with the present invention.

The method 500 begins and with the disassembling of a stock image sensor 200, 300 commercially available such as a BESiA/9959 Broadband Enhanced Spectrum Integrated Array.

One or more cut filters are removed 504 from the image sensor 200, 300, including, in the preferred embodiment, one or more infrared (IR) or ultraviolet (UV) filters. The IR and UV filters may be one and the same or may comprise separate filters.

The custom balance profile associated with output from the image sensor and/or a digital camera comprising the image sensor, is adjusted. A new white balance profile may be applied 506 to output from the image sensor. In various embodiments, the new white balance profile applied 506 is customized for each image sensor modified rather than being predetermined for image sensor of the same type. This customization is realized through use of a grey card in a plurality of lighting settings until an optimal white balance is achieved.

A clear window may optionally be introduced 508 to the image sensor. This clear window may be introduced 508 in place of the removed cut filter(s). Once positioned, the photodetector array in the image sensor is recalibrated, meaning the distance between photodetector array and one or more of the clear window and other components of the image sensor is optimized.

One or more absorbable and/or conductive materials are disposed 512 behind the image sensor and/or the photodetector array to promote heat sinking. These materials may comprise aluminum materials machined for this purpose.

In various embodiments, the modified image sensor is repackaged, or disposed, within a rugged or more appropriate outer housing, which may be aluminum, steel, titanium, polymeric, or made from any metal alloy or other non-metallic materials. The image sensor in these embodiments are optionally disposed 514 within the outer housing behind a transparent protective window, which may be glass. In various embodiments, the housing may be waterproof, weather sealed, or otherwise formed to withstand impact, inclimate and extreme weather conditions and temperature variation, and the like.

Optics faster than F/1.1 may be disposed, inserted or integrated 516 in front of the image sensor or photodetector array within the image sensor, including an F/0.95 lens or other lenses known to those of skill in the art.

The modified image sensor may be included or incorporated 524 in a COTI, OLED binocular, or the like as known to those of skill in the art. Finally, the output from the modified sensor, in whatever package it is embodied, may blended imaging output from the imaging sensor with thermal imaging data from a separate sensor to create a fused color digital image as known to those of skill in the art.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of modifying a stock image sensor to achieve hyperspectral imaging capability in low light, the steps of the method comprising:
disassembling a stock CMOS image sensor;
removing one or more IR filters disposed above a photodector array;
adjusting a white balance profile to change the output from the image sensor;
recalibrating the position of the photodetector array;
incorporating the image sensor into a NVD with a rugged housing.

2. The method of claim 1, further comprising integrating a clear window above the photodetector array in place of the removed filters.

3. The method of claim 1, removing one or more UV filters disposed above a photodector array.

4. The method of claim 1, further comprising integrating an optic faster than F/1.1.

5. The method of claim 1, wherein adjusting the white balance profile includes:
using a grey card to test the modified image sensor in a plurality of different lighting conditions to determine an optimal balance for the modified sensor, and
one or more of:
increasing color temperature settings;
shifting white balance coloring; and
decreasing color temperature settings.

6. The method of claim 1, further comprising disposing the image sensor behind a clear glass protective window in a rugged housing.

7. The method of claim 1, further comprising integrating the image sensor into a WUXGA OLED binocular device for low light viewing.

8. The method of claim 1, further comprising blending imaging output from the imaging sensor with thermal imaging data from a separate sensor to create a fused color digital image.

9. A method of modifying a stock image sensor to achieve hyperspectral imaging capability in low light, the steps of the method comprising:
disassembling a stock CMOS image sensor;
removing one or more IR filters disposed above a photodector array;
applying a custom white balance profile to output from the image sensor;
recalibrating the position of the photodetector array;
incorporating the image sensor into a NVD with a rugged housing;
integrating a clear window above the photodetector array in place of the removed filters;
integrating an optic faster than F/1.1.

10. The method of claim 11, further comprising disposing the image sensor behind a clear glass protective window.

11. The method of claim 11, further comprising integrating the image sensor into a WUXGA OLED binocular device for low light viewing.

12. The method of claim 11, further comprising blending imaging output from the imaging sensor with thermal imaging data from a separate sensor to create a fused color digital image.

13. A method of modifying a stock digital camera to achieve hyperspectral imaging capability in low light, the steps of the method comprising:
disassembling a stock CMOS image sensor in the camera;
removing one or more IR filters disposed above a photodector array;
adjusting a white balance profile to change the output from the image sensor;
recalibrating the position of the photodetector array relative to one or more filters;
incorporating the image sensor into a NVD with a rugged housing.

14. The method of claim 14, further comprising integrating a clear window above the photodetector array in place of the removed filters.

15. The method of claim 14, removing one or more UV filters disposed above a photodector array.

16. The method of claim 14, further comprising integrating an optic faster than F/1.1.

17. The method of claim 14, wherein adjusting the white balance profile includes:
using a grey card to test the modified image sensor in a plurality of different lighting conditions to determine an optimal balance for the modified sensor, and
one or more of:
increasing color temperature settings;
shifting white balance coloring; and
decreasing color temperature settings.

18. The method of claim 14, further comprising disposing the image sensor behind a clear glass protective window in a rugged housing.

19. The method of claim 14, further comprising blending imaging output from the imaging sensor with thermal imaging data from a separate sensor to create a fused color digital image.
